(19) United States
(12) Patent Application Publication
(10) Pub. No.: US 2005/0142334 A1
(43) Pub. Date: Jun. 30, 2005

(54) Orthotic apparatus and sheet with laminated structure

(76) Inventors: Saburo Mikata, Gamou-gun (JP); Juichi Morita, Ikoma-shi (JP); Masafumi Kaji, Souraku-gun (JP)

Correspondence Address: JORDAN AND HAMBURG LLP, 122 EAST 42ND STREET, SUITE 4000, NEW YORK, NY, 10168, US

(21) Appl. No.: 10/503,854

(22) PCT Filed: Oct. 21, 2002
(86) PCT No.: PCT/JP02/10894

(30) Foreign Application Priority Data
Jan. 30, 2002 (JP) 2002-21724

(51) Int. Cl. B32B 3/30; B32B 3/12

(52) U.S. Cl. 428/190; 428/292.1; 428/304.4; 428/158; 428/163

(57) ABSTRACT

A laminated brace such as a support or the like capable of quickly absorbing perspiration produced on the surface of a user's body that is in contact with the brace and releasing it to the exterior of the brace so as to prevent the contact surface from getting sweaty, and a laminated sheet such as a bathroom rug or the like capable of quickly releasing absorbed moisture to the exterior of the sheet so as to be dried in a short time.

A material formed by compression molding of an open cell urethane foam is used as an inner material (22). A liner material (21) placed over each of the inner and outer sides of the inner material is made of fibers between which the spaces are narrow. Thus, perspiration (52) can be wicked by the liner material to be released through a great number of channels formed from open cells (33) within the inner material to the exterior of the brace.

### TECHNICAL FIELD

The present invention relates to sheets such as, for example, bathroom rugs, mats for persons suffering from incontinence, and bed sheets for prevention of pressure sore, and braces to be worn on a user's body.

### BACKGROUND ART

Typically, in braces to be worn on a user's body, e.g., supports, elastic chloroprene rubber has been used for the base material. However, such a base material of chloroprene rubber is poor in water permeability as well as being not breathable, thereby tending to cause the contact surface between the brace and the body of a wearer to be sweaty. In order to solve the problem, some braces have been proposed that have a base material of closed cell neoprene rubber provided with a plurality of through holes so as to provide breathability and that have a moisture-absorbing and quick-drying fabric placed over each of the inner and outer sides of the base material so as to prevent the body surface in contact with the brace from getting sweaty (see, for example, Japanese patent laid-open publication Nos. 2000-37407, 2000-37408, and 2000-37409). Another brace is also known that uses open cell latex sponge with breathability as the base material so as to prevent the body surface in contact with the brace from getting sweaty (see, for example, Japanese patent laid-open publication No. HEI 9-266927).

Further, there are known sheets such as bathroom rugs or the like that are made of a fabric or the like and thus have moisture absorbing property in some degree.

However, in such a brace as disclosed in the Japanese patent laid-open publication No. 2000-37407, which is designed to provide breathability by forming the plurality of through holes in the base material of closed cell neoprene rubber, it is almost impossible to release perspiration, which is wicked away from the body by the fabric, to the exterior of the brace because moisture within the base material can pass only through the through holes provided for ventilation. Therefore, the brace fails to sufficiently inhibit the body surface in contact therewith from getting sweaty. Such a brace as disclosed in the Japanese patent laid-open publication No. HEI 9-266927, which uses open cell latex sponge as the base material, can hardly absorb perspiration produced on the body surface in contact with the brace because the inner and outer sides of the base material are covered with a nylon fabric poor in moisture absorbing property. Therefore, the brace also fails to sufficiently inhibit the contact surface from getting sweaty.

Although the conventional fabric sheets which is used as bathroom rugs or the like can absorb moisture in some degree, they fail to quickly release the absorbed moisture to the exterior. Thus, it is time consuming to dry such a sheet.

The present invention has been made to solve the above mentioned problems, and an object of the present invention is to provide a laminated brace that can quickly absorb perspiration produced on the body surface in contact with the brace for release to the exterior of the brace so as to sufficiently prevent the contact surface from getting sweaty. Another object of the present invention is to provide a laminated sheet that can quickly release absorbed moisture to the exterior of the sheet so as to be dried in a short time.

### DISCLOSURE OF THE INVENTION

In order to attain the above mentioned objectives, a laminated sheet according to an aspect of the present invention comprises: a base material which is either an open cell foam or a material formed by compression molding of the open cell foam; and a fabric placed over each of inner and outer sides of the base material, wherein the fabric is made of fibers between which spaces are narrower than spaces between fibers of a common polyester fabric.

In the above configuration, since the fabric placed over each of the inner and outer sides of the base material is made of fibers between which spaces are narrower than those between fibers of a common polyester fabric, it can wick moisture from the surface of the sheet by the capillary phenomenon. Further, the base material, which is an open cell foam or a material formed by compression molding of the open cell foam, has therein a great number of channels formed from open cells, so that the moisture absorbed by the fabric can be released through the channels to the exterior of the sheet. Especially in the case where the material formed by compression molding of the open cell foam is used as the base material, the channels to pass moisture are narrow as compared to the case where the standard open cell foam is used, so that the base material itself can wick moisture by the capillary phenomenon. As a result, the sheet can effectively absorb moisture on the surface thereof and quickly release the absorbed moisture to the exterior thereof so as to be dried in as short time.

According to another aspect of the present invention, a laminated sheet comprises: a base material which is either an open cell foam or a material formed by compression molding of the open cell foam; and a fabric placed over each of inner and outer sides of the base material, wherein the fabric is made of fibers configured to have grooves in cross section.

In such a configuration, since the fabric placed over each of the inner and outer sides of the base material is made of fibers configured to have grooves in cross section, it can wick moisture from the surface of the sheet through the narrow groove by the capillary phenomenon.

Preferably, in the above, a surface of the sheet is provided with projections and depressions. This can provide increased surface area of the sheet as compared to the case where the surface of the sheet is flat. Thus, the time required for moisture released to the exterior of the sheet to evaporate can be reduced.

According to another aspect of the present invention, a laminated brace to be worn on a user's body, comprises: a base material which is either an open cell foam or a material formed by compression molding of the open cell foam; and a fabric placed over each of inner and outer sides of the base material, wherein the fabric is made of fibers between which spaces are narrower than spaces between fibers of a common polyester fabric.

In such a configuration, since the fabric placed over each of the inner and outer sides of the base material is made of fibers between which spaces are narrower than those between fibers of a common polyester fabric, it can wick perspiration away from the body surface in contact with the brace by the capillary phenomenon. Further, the base material, which is an open cell foam or a material formed by compression molding of the open cell foam, has therein a great number of channels formed from open cells, so that the perspiration absorbed by the fabric can be released through the channels to the exterior of the brace. Especially in the case where the material formed by compression molding of the open cell foam is used as the base material, the channels to pass moisture are narrow as compared to the case where the standard open cell foam is used, so that the base material itself can wick perspiration. As a result, the brace can prevent the body surface in contact therewith from getting sweaty.

According to another aspect of the present invention, a laminated brace to be worn on a user's body, comprises: a base material which is either an open cell foam or a material formed by compression molding of the open cell foam; and a fabric placed over each of inner and outer sides of the base material, wherein the fabric is made of fibers configured to have grooves in cross section.

In such a configuration, since the fabric placed over each of the inner and outer sides of the base material is made of fibers configured to have grooves in cross section, it can wick perspiration away from the body surface in contact with the brace through the narrow groove.

Preferably, in the above, a side of the brace that is opposite to a side to be in contact with the body is provided with projections and depressions. In such a configuration, the side of the brace that is opposite to the side to be in contact with the body can increase in area as compared to the case where it is flat. Thus, the time required for perspiration released to the exterior of the brace to evaporate can be reduced.

In the above, a side of the brace that is to be in contact with the body may be provided with projections and depressions. For example, the projections and depressions can be configured to conform to the muscle of a human body so as to protect the muscle of a human body.

### BRIEF DESCRIPTION OF THE DRAWINGS

FIG. 1 is a plan view of a laminated brace according to a first embodiment of the present invention.

FIG. 2 shows the brace during use on the arm of a user.

FIG. 3 is a cross sectional view of the brace taken along line A-A of FIG. 1.

FIG. 4a is cross sectional views of a urethane foam, from which an inner material for the brace is formed, and the inner material formed by compression molding of the urethane foam, and FIG. 4b is cross sectional views of a urethane foam, from which an inner material for the brace is formed, and the inner material formed by compression molding of the urethane foam.

FIG. 5 is a cross sectional view of an inner material for a conventional brace.

FIG. 6 shows the respective inner materials for the conventional brace and the brace according to this embodiment, which are being tested for comparing their moisture absorbing properties.

FIG. 7 shows the details and results of the test.

FIG. 8a shows moisture within the inner material for the conventional brace and moisture on a cotton fabric when drops of water on the inner material is rubbed with a finger, and FIG. 8b shows moisture within the inner material for the conventional brace and moisture on a cotton fabric when drops of water on the inner material is rubbed with a finger.

FIG. 9a shows moisture within the inner material for the brace according to the embodiment when moisture on the inner material is rubbed with a finger, and FIG. 9b shows moisture on the cotton fabric when moisture on the inner material for the brace according to the embodiment is rubbed with a finger.

FIG. 10 is a cross sectional view of fibers included in a liner material for the brace according to the first embodiment of the present invention.

FIG. 11 is a cross sectional view of fibers included in a liner material for the conventional brace.

FIG. 12 shows the brace absorbing perspiration produced on the body surface in contact with the brace and releasing the perspiration to the exterior of the brace.

FIG. 13 is a perspective view of a bathroom rug according to a second embodiment of the present invention.

### BEST MODES FOR EMBODYING THE INVENTION

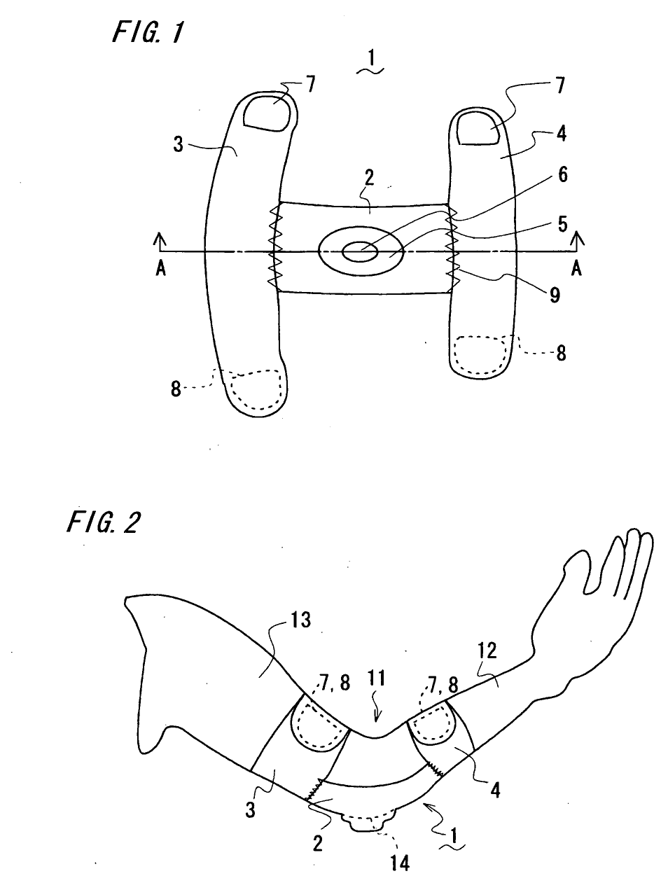

Referring now to the accompanying drawings, an elbow brace (support) and a bathroom rug each embodying the present invention will be described. In the first embodiment, the present invention is applied to an elbow support. FIG. 1 shows the inner side (the side to be in contact with a user's body) of the elbow support according to the first embodiment. The elbow support 1 includes a support portion 2 for protecting the elbow of a user and straps 3 and 4 which are members for holding the elbow support 1 on the user's arm. The support portion 2 has first and second buttresses 5 and 6 for elbow protection in the center region thereof. Each of the straps 3 and 4 has velcro fastening portions 7 and 8, which are provided at the inner side and the outer side (the side opposite to the inner side), respectively. The support portion 2 and each of the straps 3 and 4 are stitched together with a thread 9.

FIG. 2 shows the elbow support 1 during use. When the elbow support 1 is worn on a user's arm 11, the long and short straps 3 and 4 are mounted around the upper arm 13 and the forearm 12, respectively, with the second buttress 6 of the support portion 2 pressed against the center region of the elbow 14. Then, the velcro fastening portions 7 and 8 provided on each of the two straps 3 and 4 are joined so as to hold the support portion 2 in the position.

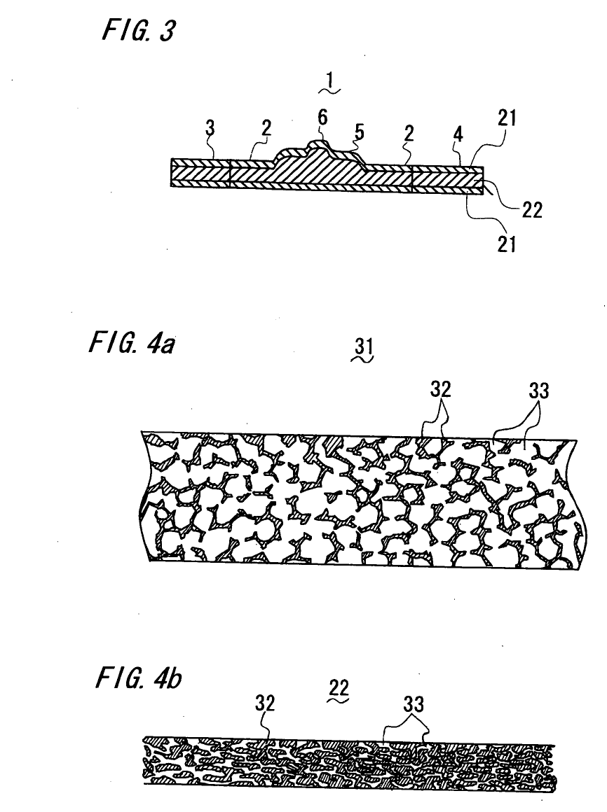

Referring to FIG. 3, a description will be made as to the inner structure of the support portion 2 and the straps 3 and 4. FIG. 3 is a cross sectional view of the elbow support 1 taken along the line A-A of FIG. 1. The support portion 2 and the straps 3 and 4 each include an inner material 22 (base material in claims) formed by compression molding of an open cell urethane foam and a liner material 21 (fabric in claims) placed over each of the inner and outer sides of the inner material 22. A portion of the inner material 22 that is located at the first and second buttresses 5 and 6 in the center region of the support portion 2 includes a large volume of cells as compared to the rest of the inner material 22 within the support portion 2, thus being higher than the rest as shown in FIG. 3. The inner material 22 is higher at the second buttress 6 than at the first buttress 5. That is because the portion of the inner material 22 that is located at the second buttress 6 to be in contact with the center region of the elbow 14 includes a larger volume of cells than the portion of the inner material 22 that is located at the first buttress 5 to be in contact with the peripheral region of the elbow 14 in order to protect the center region of the elbow 14 surely. The liner material 21 is a fabric made mainly of Technofine™ which is polyester fiber with moisture-absorbing and quick-drying properties. The Technofine™ contains 85% polyester and 15% polyurethane.

The support portion 2 and the straps 3 and 4 are formed by covering each of the inner and outer sides of the inner material 22 with the liner material 21 and by heating and pressing the covered inner material 22 for compression molding. In the heating and pressing step, pressure applied to the first and second buttresses 5 and 6 in the center region of the support portion 2 is lower than pressure applied to the rest of the support portion 2. Further, pressure applied to the second buttress 6 is lower than that applied to the first buttress 5. As a result, the inner material 22 includes a larger volume of cells at the second buttress 6 than at the first buttress 5, where the inner material 22 includes a larger volume of cells than at the portion around the first buttress 5.

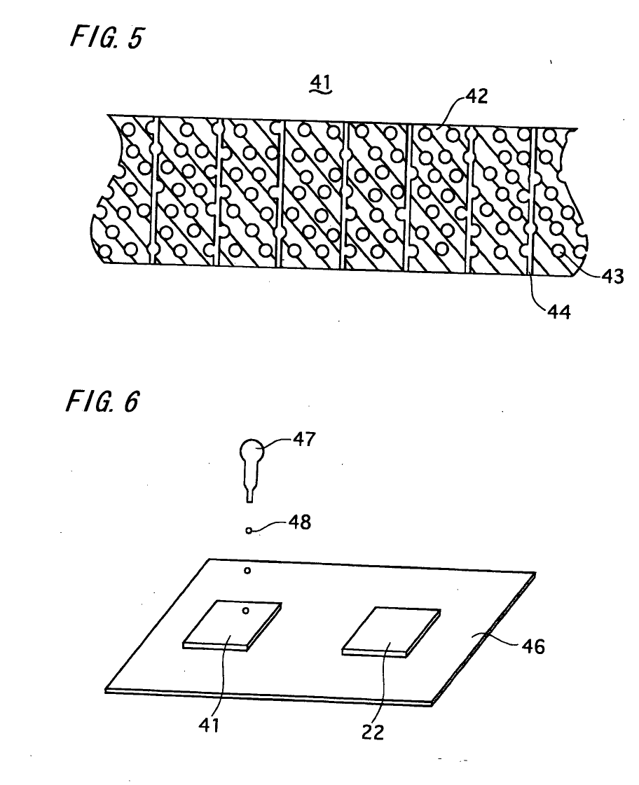

Referring now to FIGS. 4a, 4b, and 5, the inner material 22 will be described in detail. FIGS. 4a and 4b show a urethane foam 31 from which the inner material 22 is formed and the inner material 22 formed by compression molding of the urethane foam 31, respectively. FIG. 5 shows a neoprene foam that is one of inner materials for conventional elbow supports. As shown in FIG. 5, the neoprene foam 41, which is one of conventional inner materials, is a closed cell foam, so that cells 43 within a neoprene layer 42 are not linked with each other. Therefore, the conventional inner material of the neoprene foam 41 is provided with through holes 44 so as to be breathable. However, in the neoprene foam 41, moisture can pass only through the through holes 44, which are small in number. Thus, the neoprene foam can hardly release perspiration to the exterior of the elbow support 1. On the other hand, as shown in FIGS. 4a and 4b, the urethane foam 31 that is an open cell foam and the inner material 22 formed by compression molding of the urethane foam 31 have a great number of channels for passage of moisture that are formed from cells 33 linked with each other. Thus, perspiration can be released through the channels to the exterior of the elbow support 1.

As can be seen from FIGS. 4a and 4b, the compression molded inner material 22 has a smaller volume of cells 33 and thus have less spaces between parts of urethane resin 32 than the original urethane foam 31. Thus the channels to pass moisture in the inner material 22 are narrower than those in the original urethane foam 31. As a result, the inner material 22 has enhanced ability to wick moisture by the capillary phenomenon as compared to the original urethane foam 31, thus allowing perspiration absorbed by the liner material 21 that is in contact with the body of a wearer to be smoothly released to the exterior of the elbow support 1. Moreover, by compression molding the original urethane foam 31 to increase the density of the urethane resin 32 in the urethane foam 31 as described above, the resultant inner material 22 of the urethane resin 32 can have contractility and flexibility as favorable as a neoprene rubber which is used as an inner material in conventional elbow supports.

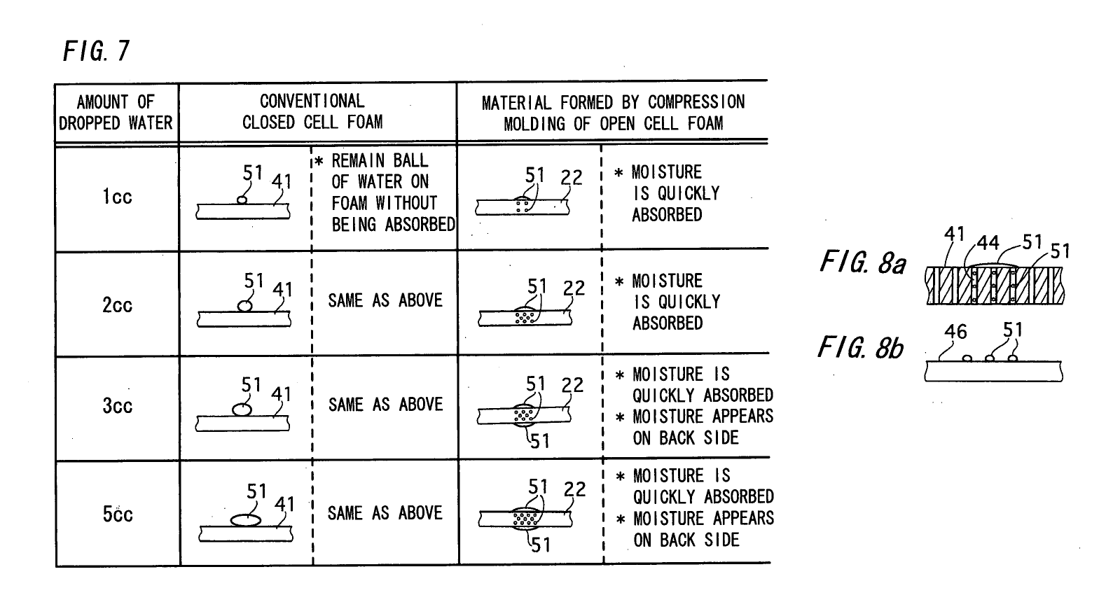

Referring now to FIGS. 6 and 7, the moisture absorbing property of the inner material 22 will be described in comparison with the neoprene foam 41 that is one of conventional inner materials. As shown in FIG. 6, a test of water absorbing property has been conducted on the neoprene foam 41 and the inner material 22 by placing the two on a cotton fabric 46 and dropping predetermined amount of water 48 with a dropper 47. The result is shown in FIG. 7. When 1-5 cc of water 48 is successively dropped onto the conventional closed cell neoprene foam 41 with the dropper 47, the moisture 51 remains round on the neoprene foam 41 without being absorbed into the neoprene foam 41 due to lack of channels to pass moisture. On the other hand, the inner material 22 formed by compression molding of the open cell urethane foam 31 has a great number of channels to pass moisture. Thus, when 1-5 cc of water 48 is successively dropped onto the inner material 22, the moisture 51 on the inner material 22 is absorbed into the inner material 22 as shown in FIG. 7. After about ten minutes since more than 3 cc of water is dropped, the moisture 51 appears on the side (back side) opposite to the side where the water 48 has been dropped.

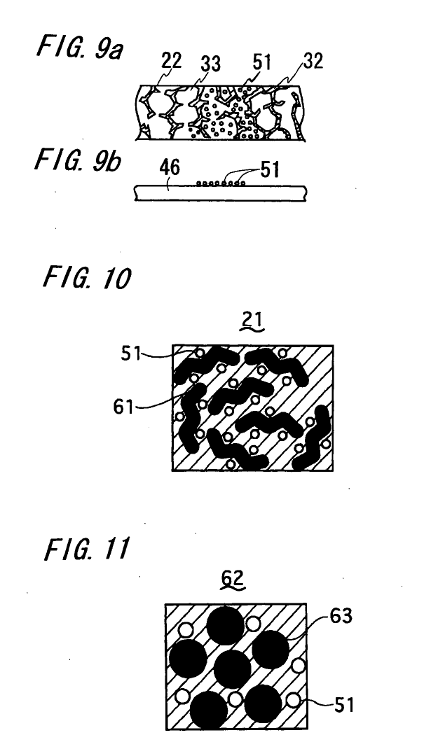

When 5 cc of water 48 is dropped onto the neoprene foam 41 with the dropper 47 and drops of the water 48 is rubbed on the neoprene foam 41 with a finger, the moisture 51 on the neoprene foam 41 is spread on the surface of the neoprene foam 41 with very little absorption into the neoprene foam 41 as shown in FIG. 8a. Only the slight moisture 51 which passed through the through holes 44 appears on the cotton fabric 46 as shown in FIG. 8b. On the other hand, when 5 cc of water 48 is dropped onto the inner material 22 with the dropper 47 and the moisture 51 remaining on the inner material 22 is rubbed with a finger, the moisture 51 on the inner material 22 is almost entirely absorbed into the inner material 22 to pass through the channels formed from the open cells 33 as shown in FIG. 9a, and thus appears on the cotton fabric 46 as shown in FIG. 9b.

As can be seen from the test result shown in FIGS. 7 to 9, the conventional closed cell neoprene foam 41 absorbs water very poorly due to few channels to pass moisture while the inner material 22 made of the open cell foam can absorb water powerfully and quickly owing to the great number of channels to pass moisture.

Referring to FIGS. 10 and 11, a description will be made as to moisture-absorbing and quick-drying properties of the liner material 21 shown in FIG. 3. As shown in FIG. 10, the liner material 21 is made of Technofine™ fibers 61. The Technofine™ fiber 61 is configured to have W-shaped grooves in cross section. Thus, the liner material 21 can smoothly pass moisture via the W-shaped grooves. The void space of the W-shaped groove is minute, so that a passage of moisture in the liner material 21 is narrower than that in a material 62 made of conventional regular polyester fibers 63 shown in FIG. 11. Accordingly, the liner material 21 at the inner side (the side to be in contact with the body of a wearer) can quickly wick perspiration away from the surface that is in contact with the liner material 21 by the capillary phenomenon. The liner material 21 at the outer side allows the perspiration wicked from the inside liner material 21 by the inner material 22 to pass quickly for release to the exterior of the elbow support 1. Thus, the elbow support 1 can evaporate in a short time perspiration produced on the contact surface between the support and the body of a wearer so as to sufficiently prevent the contact surface from getting sweaty as well as cooling the contact surface using the heat of evaporation.

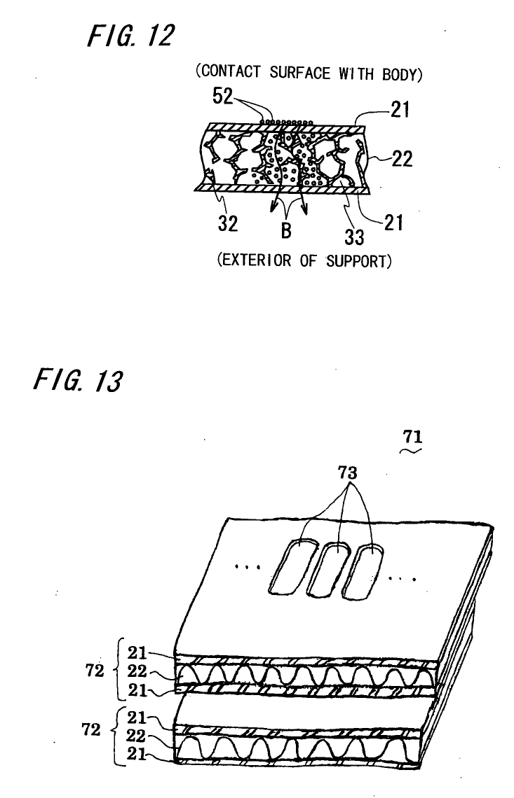

Referring to FIG. 12, how the elbow support 1 comprising the liner material 21 and the inner material 22 wicks perspiration 52 will be summed up. The elbow support 1 uses the material formed by compression molding of the open cell foam as the inner material 22, of which the inner and outer sides are covered with the liner material 21. The liner material 21 is made of fibers between which the spaces are narrower than those between fibers of a conventional polyester fabric. Thus, as indicated by the arrow B in FIG. 12, the liner material 21 can wick perspiration 52 away from the body surface in contact therewith by the capillary phenomenon, and the inner material 22 can release the perspiration 52 via the plurality of channels formed from the open cells 33 therein to the exterior of the elbow support 1. In such a manner, the elbow support 1 can sufficiently prevent the body surface in contact therewith from getting sweaty as well as cooling the contact surface using evaporation heat.

Referring now to FIG. 13, the second embodiment will be described. In the second embodiment, the present invention is applied to a bathroom rug. FIG. 13 shows the bathroom rug according to the second embodiment. This bathroom rug 71 comprises two sheets 72 each having laminated structure similar to the elbow support 1 according to the first embodiment, with one laid on the other. In FIG. 13, the sheets 72 are shown with their height (thickness) enlarged. The actual height of each of the sheets 72 is about 1 cm while the actual width of each of the sheets 72 shown in FIG. 13 is about 50-60 cm. Although there is a gap between each of the sheets 72 in FIG. 13, the sheets 72 are joined and stitched together in practice. Each of the sheets 72 comprises an inner material 22 formed by compression molding of an open cell urethane foam and a liner material 21 placed over each of the inner and outer sides of the inner material 22. Each of the sheets 72 is formed by covering each of the inner and outer sides of the inner material 22 with the liner material 21 and by heating and pressing the covered inner material 22 for compression molding. As shown in FIG. 13, the upper sheet 72 has a plurality of depressions 73 at the upper surface thereof. When forming the upper sheet 72 by compression molding, the pressure applied to the sheet 72 is higher at the depressions 73 than at the rest.

By the above described configuration, the bathroom rug 71 allows moisture on the surface thereof to wick through the liner material 21 provided at the surface by the capillary phenomenon. The liner material 21 with improved moisture absorbing property is also provided at the bottom of the bathroom rug 71 so that water spilled on a floor can be absorbed by the liner material 21 through the side face. The inner material 22 formed by compression molding of the urethane foam has a great number of channels formed from open cells therein, thus allowing moisture absorbed by the fabric to pass through the channels and be released to the exterior of the bathroom rug 71. The plurality of depressions 73 at the top of the bathroom rug 71 are formed for increasing the surface area of the rug 71. The increased surface area of the rug 71 can reduce the time required for moisture released to the exterior of the rug 71 to evaporate. Further, the depressions 73 allow a user to feel comfortable when using the bathroom rug 71.

The present invention is not limited to the above described embodiments but can be modified in various manners. For example, the fabric used as the liner material is not limited to the liner material 21 made of the Technofine™ fibers 61 that is used in the first embodiment, but may be another fabric as long as the spaces between fibers are narrow so that moisture can be wicked by the capillary phenomenon. The liner material may be made of fibers configured to have V-shaped or U-shaped grooves in cross section instead of fibers configured to have W-shaped grooves in cross section. While the above-described first embodiment uses the inner material 22 formed by compression molding of the urethane foam 31, a urethane foam or another open cell foam may be used as the inner material as it is. Further, the present invention is applied to the elbow support 1 in the above-described first embodiment, but this invention may be also applied to braces for use on wrists, ankles, etc. or leggings for use in doing exercise.

In the above-described first embodiment, the outer side (the side opposite to the side to be in contact with the body of a wearer) of the elbow support 1 is configured to be flat. Alternatively, the outer side of the elbow support may be provided with projections and depressions. Such a configuration can increase the surface area of the elbow support at the outer side, thus reducing the time required for perspiration released to the exterior of the support to evaporate as well as allowing the body surface in contact with the support to be effectively cooled.

In the above-described second embodiment, the bathroom rug 71 includes the two laminated sheets 72 with one laid on another. The number of sheets included in the bathroom rug is not necessarily two, but a single sheet, or three or more sheets may be included depending on the amount of water to be absorbed.

In the above-described second embodiment, the laminated sheet according to the present invention is applied to the bathroom rug. The laminated sheet according to the present invention may be applied to a mat for persons suffering from incontinence or a bed sheet for prevention of pressure sore.

1. A laminated sheet comprising:
a base material which is formed by compression molding of an open cell foam; and
a fabric placed over each of inner and outer sides of the base material,
wherein the fabric is made of fibers between which spaces are narrower than spaces between fibers of a common polyester fabric.

2. A laminated sheet comprising:
a base material which is formed by compression molding of an open cell foam; and
a fabric placed over each of inner and outer sides of the base material,
wherein the fabric is made of fibers configured to have grooves in cross section.

3. The laminated sheet according to claim 1 or claim 2, wherein a surface of the sheet is provided with projections and depressions.

4. A laminated brace to be worn on a user's body, comprising:
a base material which is formed by compression molding of an open cell foam; and
a fabric placed over each of inner and outer sides of the base material,
wherein the fabric is made of fibers between which spaces are narrower than spaces between fibers of a common polyester fabric.

5. A laminated brace to be worn on a user's body, comprising:
a base material which is formed by compression molding of an open cell foam; and
a fabric placed over each of inner and outer sides of the base material,
wherein the fabric is made of fibers configured to have grooves in cross section.

6. The laminated brace according to claim 4, wherein a side of the brace that is opposite to a side to be in contact with a body is provided with projections and depressions.

7. The laminated brace according to claim 4, wherein a side of the brace that is to be in contact with a body is provided with projections and depressions.

8. The laminated sheet according to claim 2, wherein a surface of the sheet is provided with projections and depressions.

9. The laminated brace according to claim 5, wherein a side of the brace that is opposite to a side to be in contact with a body is provided with projections and depressions.

10. The laminated brace according to claim 5, wherein a side of the brace that is to be in contact with a body is provided with projections and depressions.
